(19) United States
(12) Patent Application Publication
(10) Pub. No.: US 2012/0051541 A1
(43) Pub. Date: Mar. 1, 2012

(54) METHOD AND SYSTEM FOR PROVIDING CONDITIONAL ACCESS IN BROADCASTING NETWORK

(75) Inventors: YAN-ZHI WANG, Shanghai (CN); ZHANG-SHUN SHI, Shanghai (CN); BAI SUN, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/911,742

(22) Filed: Oct. 26, 2010

(30) Foreign Application Priority Data
Aug. 31, 2010 (CN) 201010268214.9

(51) Int. Cl. H04K 1/04

(52) U.S. Cl. 380/255

(57) ABSTRACT

A method and system for providing conditional access (CA) between a headend and a receiver include scrambling media data of broadcast programs and encrypting control words according to a CA system used on the headend. The receiver includes a CA virtual machine. The receiver receives the broadcast program and encrypted control words, and determines whether the media data is scrambled. If the media data is scrambled, the CA virtual machine runs a CA instance matched with the CA system, gets entitled manage message (EMM), and determines whether CA algorithm identifier in the EMM matches with CA algorithm identifier of the CA instance. If the CA algorithm identifiers match, the encrypted control words are decrypted and the scrambled media data is descrambled. If the CA algorithm identifiers do not match, updated CA algorithm is downloaded and the CA instance which has updated its CA algorithm is run.

### BACKGROUND

1. Technical Field

The present disclosure relates to method and system for providing conditional access in a broadcasting network.

2. Description of Related Art

Television programs and other kinds of broadcast programs are commonly available to the public through subscription from the respective program providers, such as cable and satellite television providers. Conditional access (CA) technology enables only authorized users to access the broadcast programs. Conditional access is typically implemented by scrambling the media data of the broadcast programs in a headend and descrambling the scrambled media data only in authorized receivers. There are multiple CA systems provided by different CA vendors, and each CA system has a CA algorithm.

A typically headend scrambles the media data of a broadcast program according to control words (CWs), encrypts the CWs according to CA algorithm of a CA system, and generates entitled manage message (EMM) and entitlement control message (ECM). The EMM includes encryption key, which encrypts the CWs, and the ECM includes encrypted CWs. The headend sends the EMM, the ECM and scrambled media data to a broadcast transmission network.

A typically receiver includes a central processing unit and a connectable smart card provided by CA vendor. The central processing unit includes a descrambler. The smart card provides secure storage of CA algorithm and also performs cryptographic operations according to the CA algorithm. The receiver gets the EMM, the ECM and the scrambled media data from the broadcast transmission network. After performing the cryptographic operations, the smart card decrypts the encrypted CWs and sends the CWs to the descrambler. The descrambler descrambles the scrambled media data, and then the user can access the broadcast program in unscrambled form.

However, the smart card, and the receiver are detachable, the CWs may easily be intercepted by hackers. In addition, when the CA vendors update their CA algorithms, the smart card must be replaced with a new smart card.

Therefore, there is room for improvement within the art.

### BRIEF DESCRIPTION OF THE DRAWINGS

Many aspects of the present method and system for providing conditional access can be better understood with reference to the following drawings. The components in the various drawings are not necessarily drawn to scale, the emphasis instead being placed upon clearly illustrating the principles of the present method and system for providing conditional access.

FIG. 1 is a block diagram of a headend of a system for providing conditional access, according to an exemplary embodiment.

FIG. 2 is a block diagram of a receiver of the system for providing conditional access, according to the exemplary embodiment.

FIG. 3 is a flowchart illustrating a process for dealing with composite signal from the headend, according to the exemplary embodiment.

FIGS. 4A-4B are flowcharts illustrating a process for responding to remote procedure call from the central processing unit shown in FIG. 2.

FIG. 5 is a flowchart illustrating a process for descrambling scrambled media data, according to the exemplary embodiment.

### DETAILED DESCRIPTION

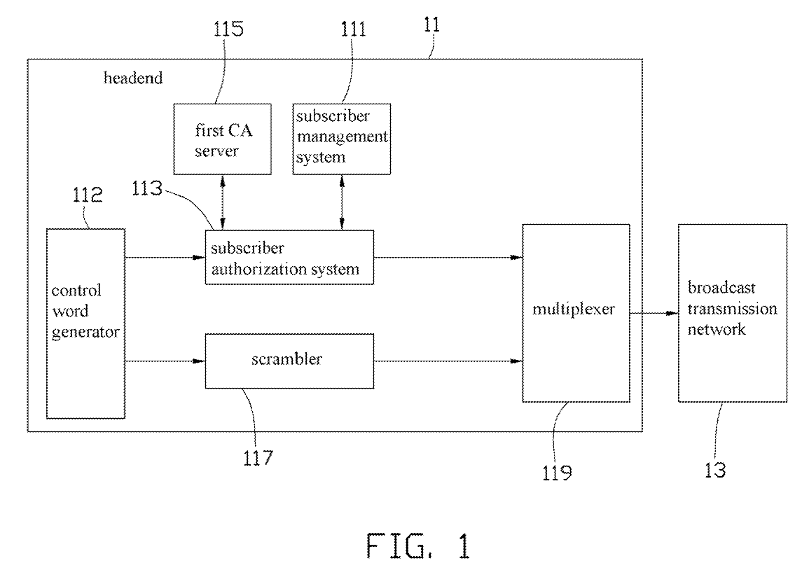

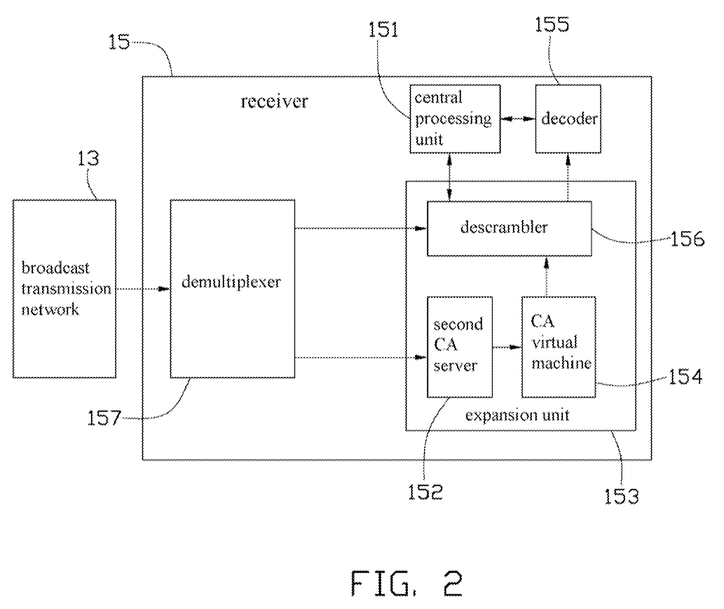

Referring to FIG. 1 and FIG. 2, a system for providing conditional access according to an exemplary embodiment includes a headend 11 and a receiver 15. The headend 11 communicates with the receiver 15 by a broadcast transmission network 13. The headend 11 is a simulcrypt headend. The headend 11 enables the use of multiple CA systems of different CA vendors. In the headend 11, the multiple CA systems use their respective CA algorithm to generate their respective EMM/ECM, and a common scrambling algorithm (CSA) scrambles the media data of broadcast programs such as movies, talk shows, and etc.

The headend 11 includes a subscriber management system (SMS) 111, a control word generator 112, a subscriber authorization system (SAS) 113, a first CA server 115, a scrambler 117, and a multiplexer 119. The subscriber management system 111 manages relevant information of the receiver 15, such as receiver subscription information, and receiver authorization information. The subscriber authorization system 113 processes EMM, ECM under control of the subscriber management system 111. The first CA server 115 stores CA algorithms of the multiple CA systems, the CA algorithms can be updated, and the receiver 15 downloads the updated CA algorithms from the first CA server 115. The multiple CA systems have their respective EMM, ECM. The first CA server 115 assigns a CA algorithm identifier (ID) of a CA system to EMM, which is corresponding to the CA system. The scrambler 117 scrambles the media data according to CWs generated by the control word generator 112.

The receiver 15 includes a central processing unit 151, a expansion unit 153, a decoder 155, and a demultiplexer 157. The central processing unit 151 and the expansion unit 153 communicate with each other. The expansion unit 153 is a chip supporting all features of java virtual machine (JVM). The expansion unit 153 includes a second CA server 152, a CA virtual machine 154, and a descrambler 156. The expansion unit 153 stores multiple CA instances, and each CA instance is corresponding to one CA system used on the headend 11. The CA virtual machine 154 runs the CA instances to deal with CA system related work on the receiver 15. Each CA instance includes a CA algorithm ID. The decoder 155 decodes the media data descrambled by the descrambler 156.

The working process of the headend 11 is as follows:

A broadcast program provider such as cable television provider, satellite television provider sends a broadcast program to the headend 11. The control word generator 112 generates CWs. According to the CWs, the scrambler 117 scrambles the media data of the broadcast program. The subscriber authorization system 113 provides encryption keys, which encrypts the CWs. Encrypted CWs, and broadcast program parameters such as broadcast program time, broadcast program price, received parameters, from the ECM. The encryption keys, and the receiver authorization information, from the EMM. In the multiplexer 119, the EMM, the ECM, the scrambled media data, and other data of the broadcast program without encryption such as broadcast program specific information (PSI) are multiplexed into a composite signal. The PSI includes a program map table (PMT), and a conditional access table (CAT). The PMT includes ECM packet identifier (PID), video PID, and audio PID; the CAT includes CA system ID, and ECM PID. The headend 11 sends the composite signal to the broadcast transmission network 13. The EMM transmission path from the headend 11 to the receiver 15 is defined as EMM transmission channel.

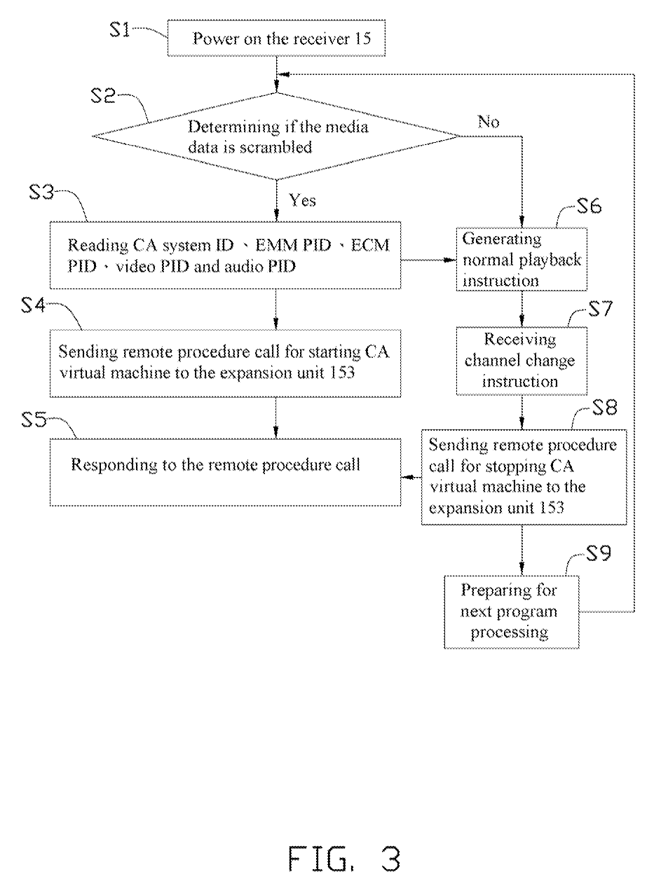

The receiver 15 gets the composite signal from the broadcast transmission network 13. The EMM, the ECM, the scrambled media data, and other data of the broadcast program without encryption are separated from the composite signal by the demultiplexer 157. When the receiver 15 is powered on, the central processing unit 151 and the expansion unit 153 start to work synchronously. Referring to FIG. 3, a process for dealing with the composite signal from the headend 11 is as follows:

In step S1, the receiver 15 is powered on.

In step S2, the central processing unit 151 determines whether the media data in the composite signal is scrambled. If the media data is scrambled, the process goes to step S3, where the central processing unit 151 reads CA system ID, EMM PID, ECM PID, video PID and audio PID from the other data of the broadcast program without encryption. If the media data is not scrambled, the process goes to step S6, where the central processing unit 151 generates normal playback instruction to control play terminal such as TV to play the broadcast program.

If the step S3 is completed, the process goes to step S4 and step S6 simultaneously.

In step S4, the central processing unit 151 sends remote procedure call (RPC) for starting the CA virtual machine 154 to the expansion unit 153.

In step S5, the expansion unit 153 responds to the RPC from the central processing unit 151.

In step S7, the central processing unit 151 receives channel change instruction. The play terminal generates the channel change instruction to user actions (eg. User changes the channel manually or by remote control) and sends the channel change instruction to the central processing unit 151.

In step S8, the central processing unit 151 sends RPC for stopping the CA virtual machine 154 to the expansion unit 153.

If the step S8 is completed, the process goes to the step S5 and step S9 simultaneously.

In step S9, the central processing unit 151 prepares for next broadcast program processing, and the process goes to step S2.

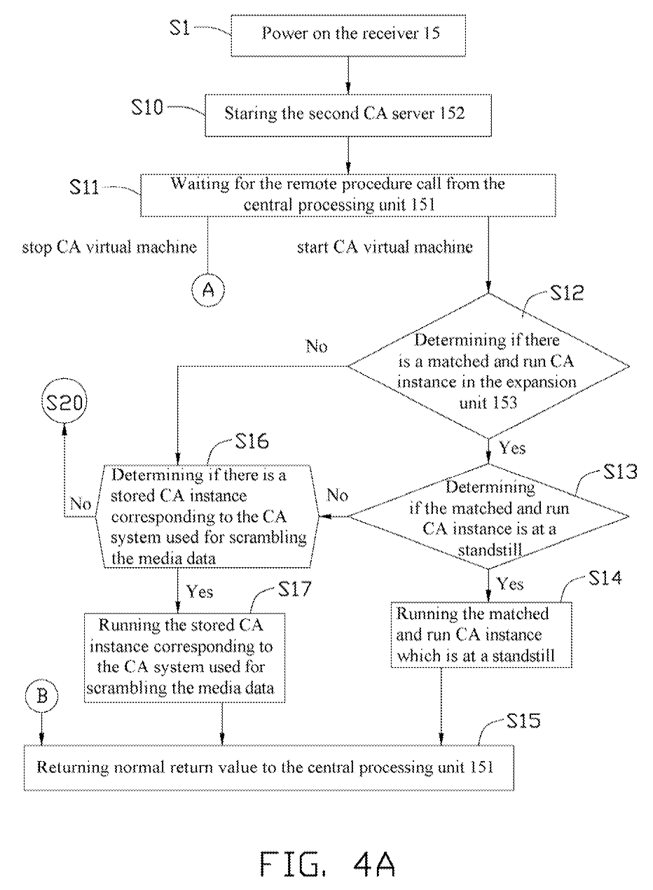

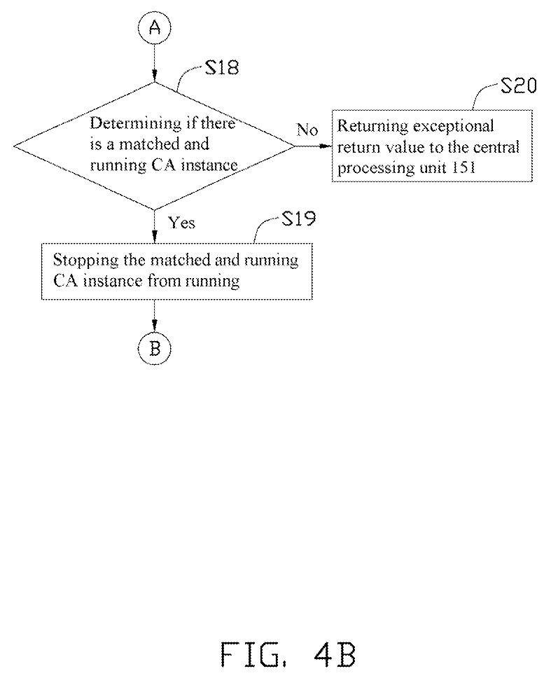

Referring to FIG. 4A and FIG. 4B, a process for responding to RPC from the central processing unit 151 is as follows:

In step S1, the receiver 15 is powered on, and the expansion unit 153 starts to work.

In step S10, the second CA server 152 is started under the control of the expansion unit 153.

In step S11, the second CA server 152 waits for the RPC from the central processing unit 151. If the second CA server 152 receives the RPC for starting the CA virtual machine 154, the process goes to step S12. If the second CA server 152 receives the RPC for stopping the CA virtual machine 154, the process goes to step S18.

In step S12, the second CA server 152 determines whether there is a matched and run CA instance (the matched and run CA instance is that a CA instance has been matched with the corresponding CA system used on the headend 11 and has been run on the CA virtual machine 154). If there is a matched and run CA instance, the process goes to step S13. If there is no matched and run CA instance, the process goes to step S16.

In step S13, the second CA server 152 determines whether the matched and run CA instance is at a standstill. As used herein, the phrase “at a standstill” refers to the fact that the matched and run CA instance has stopped running. If the matched and run CA instance is at a standstill, the process goes to step S14. If the matched and run CA instance is not at a standstill, the process goes to step S16.

In step S14, the CA virtual machine 154 runs the matched and run CA instance.

In step S15, the RPC returns normal return value to the central processing unit 151.

In step S16, the second CA server 152 determines whether there is a stored CA instance corresponding to the CA system used to scramble the media data on the headend 11. If there is a stored CA instance corresponding to the CA system used to scramble the media data, the process goes to step S17. If there is no stored CA instance corresponding to the CA system used to scramble the media data, the process goes to step S20.

In step S17, the CA virtual machine 154 runs the stored CA instance corresponding to the CA system used to scramble the media data on the headend 11.

In step S18, the second CA server 152 determines whether there is a matched and running CA instance. If there is a matched and running CA instance, the process goes to step S19. If there is no matched and running CA instance, the process goes to step S20.

In step S19, the CA virtual machine 154 stops running the matched and running CA instance.

In step S20, the RPC returns exceptional return value to the central processing unit 151.

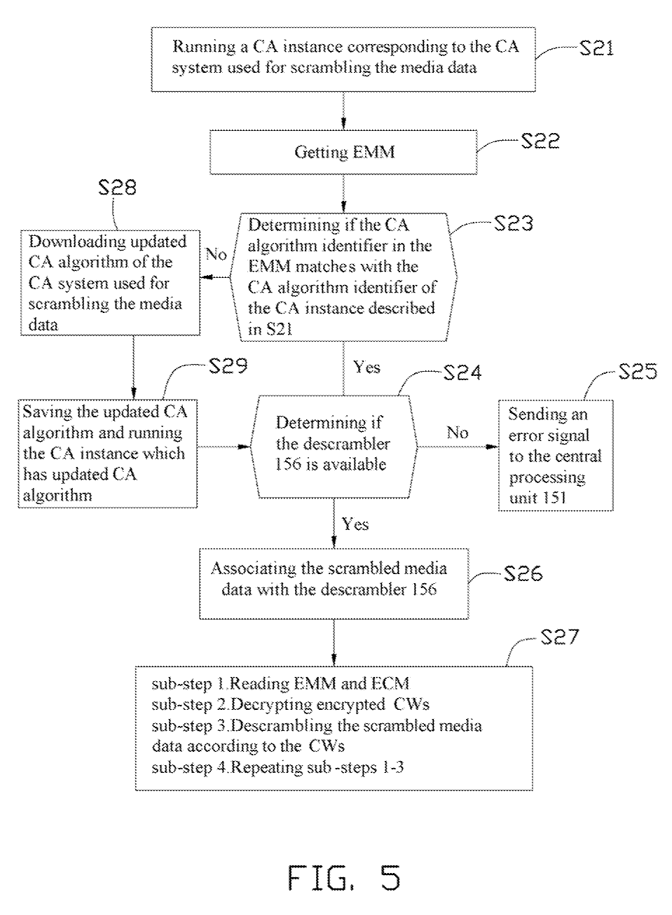

Referring to FIG. 5, a process for descrambling scrambled media data is as follows:

In step S21, the CA virtual machine 154 runs a CA instance corresponding to the CA system used to scramble the media data on the headend 11.

In step S22, the CA virtual machine 154 gets EMM.

In step S23, the CA virtual machine 154 determines whether the CA algorithm identifier in the EMM matches with the CA algorithm identifier of the running CA instance in step S21. If the CA algorithm identifiers match, the process goes to step S24. If the CA algorithm identifiers do not match, the process goes to step S28.

In step S24, the CA virtual machine 154 determines whether the descrambler 156 is available. If the descrambler 156 is not available, the process goes to step S25. If the descrambler 156 is available, the process goes to step S26.

In step S25, the CA virtual machine 154 sends an error signal to the central processing unit 151.

In step S26, the descrambler 156 associates with the scrambled media data.

Step S27 includes four sub-steps, in sub-step 1, the CA virtual machine 154 reads EMM and ECM.

In sub-step 2, the CA virtual machine 154 decrypts the encrypted CWs.

In sub-step 3, the descrambler 156 descrambles the scrambled media data according to the CWs.

In sub-step 4, repeats sub-steps 1-3.

In step S28, the CA virtual machine 154 downloads updated CA algorithm of the corresponding CA system used for scrambling the media data on the headend 11 through the EMM channel.

In step S29, the expansion unit 153 saves the CA instance which has updated its CA algorithm, the CA virtual machine 154 runs the CA instance which has updated its CA algorithm.

The headend 11 enables the use of multiple CA systems of different CA vendors. The receiver 15 can decrypt CWs encrypted by multiple CA algorithms, and the receiver 15 can download updated CA algorithm from the headend 11. If the CA vendors updates CA algorithm, the user does not need to replace anything.

In other embodiments, the decoder 155 can be integrated in the central processing unit 151.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A method for providing conditional access (CA) between a headend and a receiver including a CA virtual machine, the headend includes a control word generator and a first CA server storing CA algorithms of multiple conditional access systems, the method comprising:
scrambling media data of a broadcast program from a broadcast program provider and encrypting control words generated by the control word generator according to a CA system used on the headend;
sending the broadcast program and encrypted control words to the receiver;
determining whether media data of the broadcast program is scrambled;
if media data of the broadcast program is scrambled, reading CA system identifier of the CA system, making the CA virtual machine run a CA instance matched with the CA system;
getting entitled manage message (EMM) from the headend, and determining whether CA algorithm identifier in the EMM matches with CA algorithm identifier of the CA instance; if the CA algorithm identifiers match, reading the EMM and entitlement control message (ECM) from the headend, decrypting the encrypted control words and descrambling scrambled media data;
if the CA algorithm identifiers do not match, downloading updated CA algorithm from the first CA server and running the CA instance which has updated its CA algorithm.

2. The method for providing conditional access as claimed in claim 1, further comprising if media data of the broadcast program is not scrambled, playing the broadcast program.

3. The method for providing conditional access as claimed in claim 2, further comprising if the receiver receives channel change instruction from play terminal, making the CA virtual machine stop running a matched CA instance.

4. The method for providing conditional access as claimed in claim 3, further comprising if the CA algorithm identifiers match, determining whether a descrambler is available; if the descrambler is available, reading the EMM and ECM from the headend, decrypting the encrypted control words and descrambling the scrambled media data.

5. The method for providing conditional access as claimed in claim 4, further comprising after reading the CA system identifier of the CA system, determining whether there is a matched and run CA instance which has been matched with the CA system used on the headend and has been run on the CA virtual machine; if there is a matched and run CA instance, determining whether the matched and run CA instance is at a standstill.

6. The method for providing conditional access as claimed in claim 5, further comprising if there is no matched and run CA instance or if the matched and run CA instance is not at a standstill, determining whether there is a stored CA instance corresponding to the CA system.

7. The method for providing conditional access as claimed in claim 6, further comprising if the matched and run CA instance is at a standstill, running the matched and run CA instance.

8. The method for providing conditional access as claimed in claim 7, further comprising if there is a stored CA instance corresponding to the CA system, running the stored CA instance.

9. A system for providing conditional access (CA), comprising:
a headend for scrambling media data of broadcast programs from a broadcast program provider according to control words generated by a control word generator, and encrypting the control words, the headend includes a first CA server; and
a receiver for decrypting control words that have been encrypted and descrambling media data that have been scrambled, the receiver includes a central processing unit and a expansion unit in communication with each other;
wherein the first CA server stores CA algorithms of multiple conditional access systems; the expansion unit includes a second CA server, a CA virtual machine, and a descrambler; the CA virtual machine runs CA instances to deal with CA system related work on the receiver and sends control words that have been decrypted to the descrambler; according to remote procedure call from the central processing unit, the second CA server makes the CA virtual machine run or stop running a CA instance matched with the conditional access system used on the headend; the descrambler descrambles the media data that have been scrambled according to the control words that have been decrypted; if the CA algorithm used on the headend is updated, the CA virtual machine downloads updated CA algorithm, and the expansion unit saves the CA instance that has updated its CA algorithm.

10. The system for providing conditional access as claimed in claim 9, wherein the headend is a simulcrypt headend, and the headend enables the use of multiple conditional access systems for scrambling the media data.

11. The system for providing conditional access as claimed in claim 10, wherein the headend further includes a multiplexer for multiplexing multiple signals into a composite signal and sending the composite signal to the receiver.

12. The system for providing conditional access as claimed in claim 11, wherein the receiver further includes a demultiplexer for receiving the composite signal and demultiplexing the composite signal in to the multiple signals.

13. The system for providing conditional access as claimed in claim 12, wherein the wherein the headend further includes a control word generator and a scrambler, the scrambler scrambles the media data according to the control words generated by the control word generator.
